(19) United States
(12) Patent Application Publication
(10) Pub. No.: US 2009/0004537 A1
(43) Pub. Date: Jan. 1, 2009

(54) Fuel Cell

(76) Inventors: Yuichi Yagami, Shizuoka-ken (JP); Naohiro Takeshita, Shizuoka-ken (JP); Tsutomu Shirakawa, Shizuoka-ken (JP); Kenji Tsubosaka, Shizuoka-ken (JP); Hiroo Yoshikawa, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/087,462

(22) PCT Filed: Jan. 5, 2007
(86) PCT No.: PCT/IB2007/000025

§ 371 Date: Jul. 8, 2008

(30) Foreign Application Priority Data
Jan. 10, 2006 (JP) 2006-002969

(51) Int. Cl. H01M 2/08

(52) U.S. Cl. 429/35

(57) ABSTRACT

A fuel cell is formed by alternately stacking separators and sealing gasket-combined membrane electrode assemblies. Each sealing gasket-combined membrane electrode assembly includes a membrane electrode assembly and a sealing gasket portion. One of the sealing gasket portion and the separator has a protrusion formed on each face and extending in a stacked direction in which the separators and the sealing gasket-combined membrane electrode assemblies are stacked. The other of the sealing gasket portion and the separator has a recess in which the protrusion is fitted. The protrusions formed respectively on opposed faces of the successive sealing gasket-combined membrane electrode assemblies or the successive separators are located at different positions.

### BACKGROUND OF THE INVENTION

1. Field of the Invention

The invention relates to a fuel cell.

2. Description of the Related Art

Fuel cells produce electric energy using, commonly, hydrogen and oxygen as fuel. Because being both environmentally friendly and energy-efficient, the fuel cells have been widely developed as future energy supply systems. Some fuel cells have a stack structure where multiple membrane electrode assemblies combined with respective sealing gaskets (hereinafter, simply referred to as “sealing gasket-combined MEAs”) and multiple separators are alternately stacked on top of each other. To prevent gas leak, etc., the sealing gasket-combined MEAs and the separators need to be appropriately aligned with each other while being stacked.

For example, Japanese Patent Application Publication No. 2002-50368 (JP-A-2002-50368) describes a technology in which a gasket member is fitted to a separator to combine the separator and the gasket member with each other. This technology may be employed to appropriately align the separators and the sealing gasket-combined MEAs with each other. For example, protrusions formed on the sealing gaskets may be fitted in the respective separators to appropriately align the sealing gasket-combined MEAs and the separators with each other.

According to the technology described in Japanese Patent Application Publication No. 2002-50368 (JP-A-2002-50368), the protrusions are formed on only one face of each sealing gasket, and the protrusions formed on the sealing gaskets are fitted in the respective separators. With this structure, however, the sealing gasket-combined MEAs may be curved. To minimize such inconvenience, protrusions may be formed on both faces of each sealing gasket and the protrusions formed on the sealing gaskets may be fitted in the respective separators. With this structure, however, the protrusions, formed on the sealing gaskets that are successively arranged with the separator interposed therebetween, may interfere with each other. As a result, a malfunction may occur.

### SUMMARY OF THE INVENTION

The invention provides a fuel cell in which sealing gasket-combined MEAs and separators are appropriately aligned with each other without causing protrusions, formed on the respective sealing gasket-combined MEAs successively arranged with the separator interposed therebetween, to interfere with each other and/or without causing protrusions, formed on the respective separators successively arranged with the sealing gasket-combined MEA interposed therebetween, to interfere with each other.

An aspect of the invention relates to a fuel cell including separators; and sealing gasket-combined membrane electrode assemblies stacked alternately with the separators. According to the aspect, each sealing gasket-combined membrane electrode assembly includes a membrane electrode assembly and a sealing gasket portion; one of the sealing gasket portion and the separator has a protrusion formed on each face and extending in a stacked direction in which the separators and the sealing gasket-combined membrane electrode assemblies are stacked; the other of the sealing gasket portion and the separator has a recess in which the protrusion is fitted; and the protrusions formed respectively on opposed faces of the successive sealing gasket-combined membrane electrode assemblies or the successive separators are located at different positions.

In the fuel cell according to the above-described aspect of the invention, one of the sealing gasket portion and the separator may have the same number of protrusions on each face, and a pair of the protrusion formed respectively on one face and on the other face are located at the same position; and the paired protrusions formed on the sealing gasket-combined membrane electrode assembly or on the separator may be located at a position different from the successive sealing gasket-combined membrane electrode assembly or the successive separator.

In the fuel cell according to the above-described aspect of the invention, the separators and the sealing gasket-combined MEAs are appropriately aligned with each other using the protrusions and the recesses. Accordingly, an adhesive agent, etc. are no longer required to appropriately align the separators and the sealing gasket-combined MEAs with each other. As a result, the fuel cell is produced at lower cost. In addition; because the protrusions formed respectively on opposed faces of the successive sealing gasket-combined membrane electrode assemblies or the successive separators are located at different positions, it is possible to prevent the protrusions from interfering with each other.

In the fuel cell according to the above-described aspect of the invention, each sealing gasket portion may have the paired protrusion, and each separator may have the recess in which the protrusion is fitted.

In the fuel cell according to the above-described aspect of the invention, the paired protrusions may be formed at two positions on each sealing gasket-combined electrode assembly. In this case, curvature of the separator is suppressed. As a result, high flatness of the separator is achieved. In addition, the accuracy in aligning the separators and the sealing gasket-combined MEAs with each other increases. The paired protrusions may respectively be formed at two diagonally opposite corner portions of each sealing gasket-combined MEA. In this case, the distance between the protrusions is relatively long. This effectively suppresses curvature of the separator. In addition, the accuracy in aligning the separators and the sealing gasket-combined MEAs with each other further increases.

In the fuel cell according to the above-described aspect of the invention, the positions of the two diagonally opposite corner portions at which the paired protrusions are formed may be different between the successive sealing gasket-combined membrane electrode assemblies. In this case, it is possible to reliably prevent the protrusions from interfering with each other. A cooling medium passage may be formed in the separator.

In the fuel cell according to the above-described aspect of the invention, the protrusion may be made of the same material as that of the sealing gasket portion. In this case, the protrusions and the sealing gasket portions are produced in the same production step. As a result, the fuel cell according to the invention is produced at lower cost. Alternatively, the protrusion may be made of a material that has elasticity lower than that of the sealing gasket portion. In this case, deformation of the protrusions is suppressed. Thus, the accuracy in aligning the separators and the sealing gasket-combined MEAs with each other further increases.

In the fuel cell according to the above-described aspect of the invention, both of the sealing gasket portion and the separator may have the same number of protrusions on each face; a pair of the protrusions one formed respectively on one face and on the other face are located at the same position; the paired protrusions formed on the sealing gasket portion are located at a position different from the separator adjacent to the sealing gasket portion; and the sealing gasket portion and the separator may have the recess in which the protrusions respectively formed on the adjacent separator and on the adjacent sealing gasket portion are fitted.

In the fuel cell according to the above-described aspect of the invention, one of the sealing gasket portion and the separator may have a protrusion on each face; the protrusions respectively formed on opposite faces are located at different positions; and the other of the sealing gasket portion and the separator may have the recess in which the protrusion is fitted.

According to the above-described aspect of the invention, it is possible to appropriately align the sealing gasket-combined MEAs and the separators with each other without causing the protrusions, formed on the respective sealing gasket-combined MEAs successively arranged with the separator interposed therebetween, to interfere with each other and/or without causing the protrusions, formed on the respective separators successively arranged with the sealing gasket-combined MEA interposed therebetween, to interfere with each other.

### BRIEF DESCRIPTION OF THE DRAWINGS

The foregoing and further objects, features and advantages of the invention will become apparent from the following description of example embodiments with reference to the accompanying drawings, wherein the same or corresponding portions will be denoted by the same reference numerals and wherein:

FIG. 1 is the view schematically showing a fuel cell according to a first embodiment of the invention;

FIG. 2A is the plan view showing a cathode-facing plate of a separator according to the first embodiment of the invention;

FIG. 2B is the plan view showing an anode-facing plate of the separator according to the first embodiment of the invention;

FIG. 2C is the plan view showing an intermediate plate of the separator according to the first embodiment of the invention;

FIG. 2D is the plan view showing a sealing gasket-combined MEA according to the first embodiment of the invention;

FIG. 3A is the view used to describe the positional relationship between protrusions formed on the sealing gasket-combined MEAs and through-holes formed in the separators according to the first embodiment of the invention;

FIG. 3B is the cross-sectional view taken along the line IIIB-IIIB in FIG. 3A;

FIG. 4 is the view used to describe another example of a protrusion;

FIG. 5 is the view showing another example of the positions at which the protrusions are formed;

FIG. 6 is the view showing yet another example of the positions at which the protrusions are formed;

FIG. 7A is the view used to describe the positional relationship between protrusions formed on the sealing gasket-combined MEAs and through-holes formed in the separators according to a second embodiment of the invention;

FIG. 7B is the cross-sectional view taken along the line VIIB-VIIB in FIG. 7A;

FIG. 8 is the view used to describe the positional relationship between protrusions formed on the sealing gasket-combined MEAs and through-holes formed in the separators according to a third embodiment of the invention;

FIG. 9A is the view used to describe the positional relationship between through-holes formed in the sealing gasket-combined MEAs and protrusions formed on the separators according to a fourth embodiment of the invention;

FIG. 9B is the cross-sectional view taken along the line IXB-IXB in FIG. 9A;

FIG. 10A is the view used to describe the positional relationship between protrusions formed on the sealing gasket-combined MEAs and the separators and through-holes formed in the sealing gasket-combined MEAs and the separators according to a fifth embodiment of the invention;

FIG. 10B is the cross-sectional view taken along the line XB-XB in FIG. 10A;

FIG. 10C is the cross-sectional view taken along the line XC-XC in FIG. 10A;

FIG. 11A is the view used to describe the positional relationship between protrusions formed on the sealing gasket-combined MEAs and through-holes formed in the separators according to a sixth embodiment of the invention;

FIG. 11B is the cross-sectional view taken along the line XIB-XIB in FIG. 11A; and

FIG. 11C is the cross-sectional view taken along the line XIC-XIC in FIG. 11A.

### DETAILED DESCRIPTION OF THE EXAMPLE EMBODIMENTS

Hereafter, example embodiments of the invention will be described in detail with reference to the accompanying drawings.

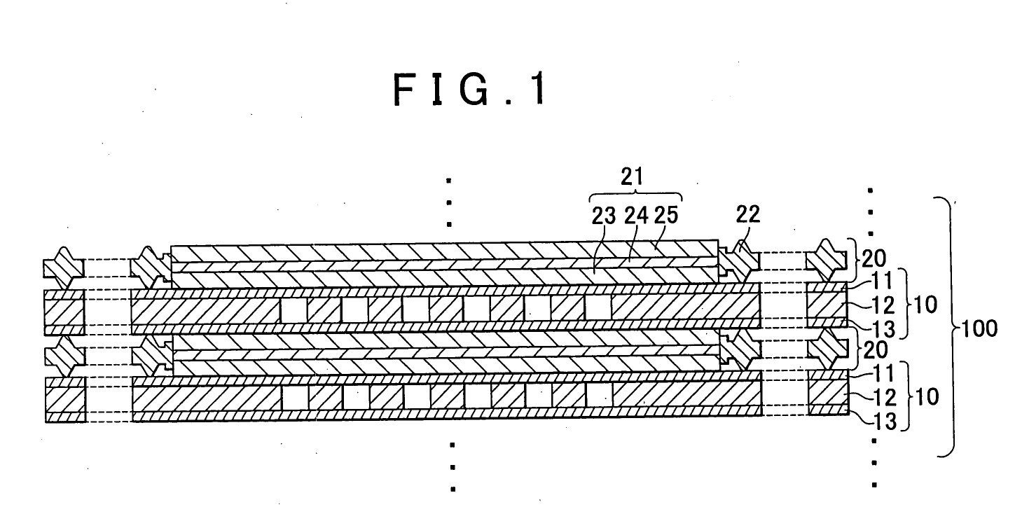

FIG. 1 is the view schematically showing a fuel cell 100 according to a first embodiment of the invention. As shown in FIG. 1, the fuel cell 100 has a structure where separators 10 and sealing gasket-combined MEAs 20 are alternately stacked on top of each other. Each separator 10 has a structure where an intermediate plate 12 is sandwiched between a cathode-facing plate 11 and an anode-facing plate 13. These three plates 11, 12, and 13 forming the separator 10 are fitted to each other by, for example, hot pressing.

Each sealing gasket-combined MEA 20 includes an MEA (membrane electrode assembly) 21 and a sealing gasket portion 22. The MEA 21 includes an electric-power generation portion 24 in which catalytic layers are formed on respective faces of an electrolyte membrane having proton conductivity; a gas diffusion layer 23 formed on the bottom face of the electric-power generation portion 24; and a gas diffusion layer 25 formed on the top face of the electric-power generation portion 24. In the first embodiment of the invention, the top portion of the MEA 21 serves as the anode, and the bottom portion of the MEA 21 serves as the cathode.

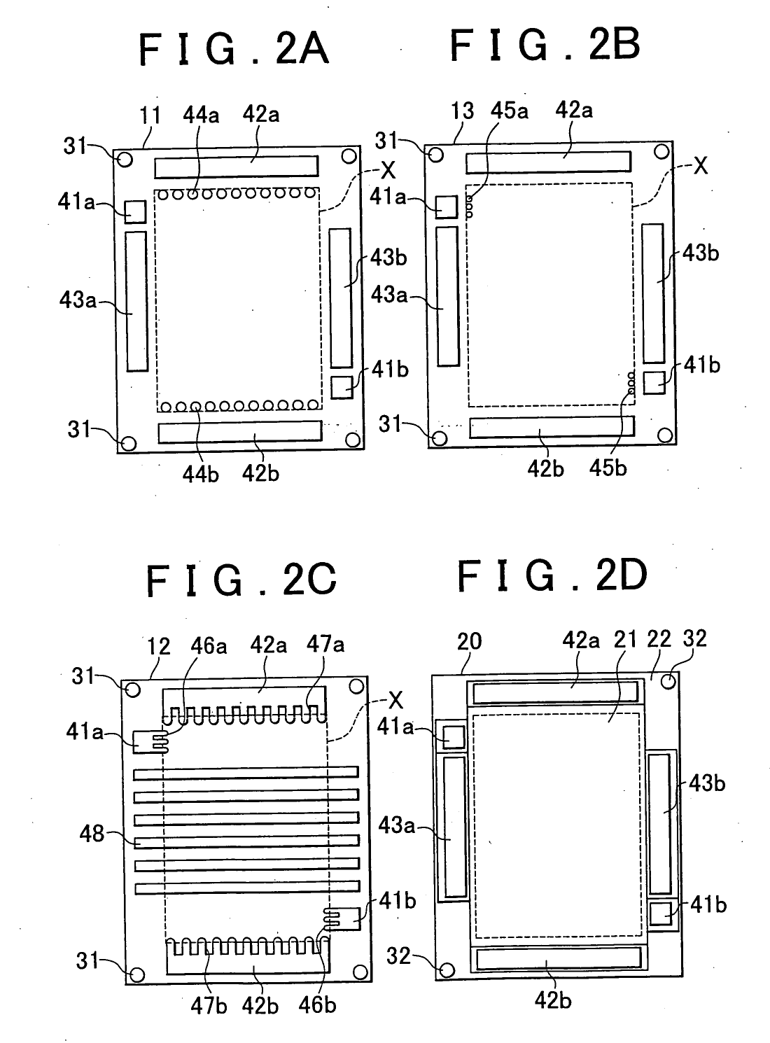

FIGS. 2A to 2D are the views used to describe the separator 10 and the sealing gasket-combined MEA 20 in detail. FIG. 2A is the plan view schematically showing the cathode-facing plate 11. FIG. 2B is the plan view schematically showing the anode-facing plate 13. FIG. 2C is the plan view schematically showing the intermediate plate 12. FIG. 2D is the plan view schematically showing the sealing gasket-combined MEA 20.

The cathode-facing plate 11 is a rectangular metal plate. This metal plate may be made of titanium, a titanium alloy, or stainless, and furnished with plating to prevent corrosion. The cathode-facing plate 11 has a thickness of, for example, approximately 0.15 millimeters (mm).

As shown in FIG. 2A, through-holes 31 are formed in respective corner portions of the cathode-facing plate 11. A portion of the cathode-facing plate 11, which faces the MEA 21 (hereinafter, such portion will be referred to as an “electric power generation region X”), is flat. Formed in a peripheral portion of the cathode-facing plate 11 are: a fuel gas supply manifold 41a, a fuel gas discharge manifold 41b, an oxidant gas supply manifold 42a, an oxidant gas discharge manifold 42b, a cooling medium supply manifold 43a, and a cooling medium discharge manifold 43b. In the cathode-facing plate 11, multiple oxidant gas supply holes 44a and multiple oxidant gas discharge holes 44b are formed. These manifolds and holes pass through the cathode-facing plate 11 in the thickness-direction of the cathode-facing plate 11.

The anode-facing plate 13 is a rectangular metal plate having substantially the same shape as that of the cathode-facing plate 11. The anode-facing plate 13 is made of the same material as that of the cathode-facing plate 11. The anode-facing plate 13 has a thickness of, for example, approximately 0.15 millimeters (mm). As shown in FIG. 2B, the through-holes 31 are formed in respective corner portions of the anode-facing plate 13. The electric power generation region X of the anode-facing plate 13 is flat.

As in the cathode-facing plate 11, formed in a peripheral portion of the anode-facing plate 13 are: the fuel gas supply manifold 41a, the fuel gas discharge manifold 41b, the oxidant gas supply manifold 42a, the oxidant gas discharge manifold 42b, the cooling medium supply manifold 43a, and the cooling medium discharge manifold 43b. In the anode-facing plate 13, multiple fuel gas supply holes 45a and multiple fuel gas discharge holes 45b are formed. These manifolds and holes pass through the anode-facing plate 13 in the thickness-direction of the anode-facing plate 13.

The intermediate plate 12 is a rectangular metal plate having substantially the same shape as that of the cathode-facing plate 11. The intermediate plate 12 is made of the same material as that of the cathode-facing plate 11. The intermediate plate 12 has a thickness of, for example, approximately 0.35 mm. As shown in FIG. 2C, the through-holes 31 are formed in respective corner portions of the intermediate plate 12.

As in the cathode-facing plate 11, formed in a peripheral portion of the intermediate plate 12 are: the fuel gas supply, manifold 41a, the fuel gas discharge manifold 41b, the oxidant gas supply manifold 42a, and the oxidant gas discharge manifold 42b. Multiple fuel gas supply passages 46a are formed in the intermediate plate 12. The multiple fuel gas supply passages 46a are communicated, at one ends, with the fuel gas supply manifold 41a, and communicated, at the other ends, with the respective fuel gas supply holes 45a. Similarly, multiple fuel gas discharge passages 46b are formed in the intermediate plate 12. The multiple fuel gas discharge passages 46b are communicated, at one ends, with the fuel gas discharge manifold 41b, and communicated, at the other ends, with the respective fuel gas discharge holes 45b.

In addition, multiple oxidant gas supply passages 47a are formed in the intermediate plate 12. The multiple oxidant gas supply passages 47a are communicated, at one ends, with the oxidant gas supply manifold 42a, and communicated, at the other ends, with the respective oxidant gas supply holes 44a. Similarly, multiple oxidant gas discharge passages 47b are formed in the intermediate plate 12. The multiple oxidant gas discharge passages 47b are communicated, at one ends, with the oxidant gas discharge manifold 42b, and communicated, at the other ends, with the respective oxidant gas discharge holes 44b. Further, multiple cooling medium passages 48 are formed in the intermediate plate 12. The multiple cooling medium passages 48 are communicated, at one ends, with the cooling medium supply manifold 43a, and communicated, at the other ends, with the cooling medium discharge manifold 43b. These passages pass through the intermediate plate 12 in the thickness-direction of the intermediate plate 12.

As shown in FIG. 2D, the sealing gasket-combined MEA 20 is formed by connecting the sealing gasket portion 22 to the peripheral end portion of the MEA 21. The sealing gasket portion 22 is made, for example, of a resin material such as silicone rubber, butyl rubber or fluoro rubber. The sealing gasket portion 22 is formed in the method in which the peripheral end portion of the MEA 21 is placed in the cavity of a metal die and then the resin material is injected into the cavity to mold the sealing gasket portion 22 onto the peripheral end portion. According to this method, the MEA 21 and the sealing gasket portion 22 are connected to each other without any gaps. It is, therefore, possible to prevent the cooling medium, the oxidant gas and the fuel gas from leaking from the portion at which the MEA 21 and the sealing gasket portion 22 are connected to each other.

Protrusions 32 are formed on the sealing gasket portion 22 of each sealing gasket-combined MEA 20. The protrusions 32 are formed at the two diagonally opposite corner portions among the four corner portions of each sealing gasket-combined MEA 20. The protrusions 32 are formed at the positions corresponding to the two through-holes 31 among the four through-holes 31. The protrusions 32 are made of the same material as that of the sealing gasket portions 22. Accordingly, the protrusions 32 and the sealing gasket portions 22 are produced in the same production step. As a result, the fuel cell 100 is produced at lower cost.

As in the cathode-facing plate 11, formed in the sealing gasket portion 22 are: the fuel gas supply manifold 41a, the fuel gas discharge manifold 41b, the oxidant gas supply manifold 42a, the oxidant gas discharge manifold 42b, the cooling medium supply manifold 43a, and the cooling medium discharge manifold 43b. The sealing gasket portion 22 provides sealing between the two separators 10 that contact the top face and the bottom face of the sealing gasket portion 22, respectively. The sealing gasket portion 22 also provides sealing between the periphery of the MEA 21 and the periphery of each manifold. In FIG. 2D, the sealing line SL that shows the portion at which the sealing gasket portion 22 and the separator 10 contact each other is indicated to make it easier to understand the figure.

Next, the outline of the operation of the fuel cell 100 will be described. First, fuel gas that contains hydrogen is supplied to the fuel gas supply manifold 41a. The fuel gas is supplied, through the fuel gas supply passages 46a and the fuel gas supply holes 45a, to the anode-side gas diffusion layer 25 of the MEA 21. The hydrogen contained in the fuel gas is converted into protons in the catalytic layer of the electric-power generation portion 24. The protons produced by such conversion pass through the electrolyte membrane of the electric-power generation portion 24, and then reach the cathode-side catalytic layer.

Meanwhile, the oxidant gas that contains oxygen is supplied to the oxidant gas supply manifold 42a. The oxidant gas is supplied to the cathode-side catalytic layer of the electric-power generation portion 24 through the oxidant gas supply passages 47a, the oxidant gas supply holes 44a, and the cathode-side gas diffusion layer 23 of the MEA 21. Then, water is produced from the oxygen in the oxidant gas and the protons that have reached the cathode-side catalytic layer, and electric power is generated. The generated electric power is collected through the separator 10.

The cooling medium such as coolant is supplied to the cooling medium supply manifold 43a. The cooling medium flows through the cooling medium passage 48, thereby cooling the fuel cell 100. Thus, the temperature of the fuel cell 100 is adjusted to an appropriate value. The cooling medium that has flowed through the cooling medium passage 48 is discharged to the outside of the fuel cell 100 through the cooling medium discharge manifold 43b. The fuel gas that was not used for electric power generation is discharged to the outside of the fuel cell 100 through the fuel gas discharge holes 45b, the fuel gas discharge passages 46b and the fuel gas discharge manifold 41b. Also, the oxidant gas that was not used for electric power generation is discharged to the outside of the fuel cell 100 through the oxidant gas discharge holes 44b, the oxidant gas discharge passages 47b and the oxidant gas discharge manifold 42b.

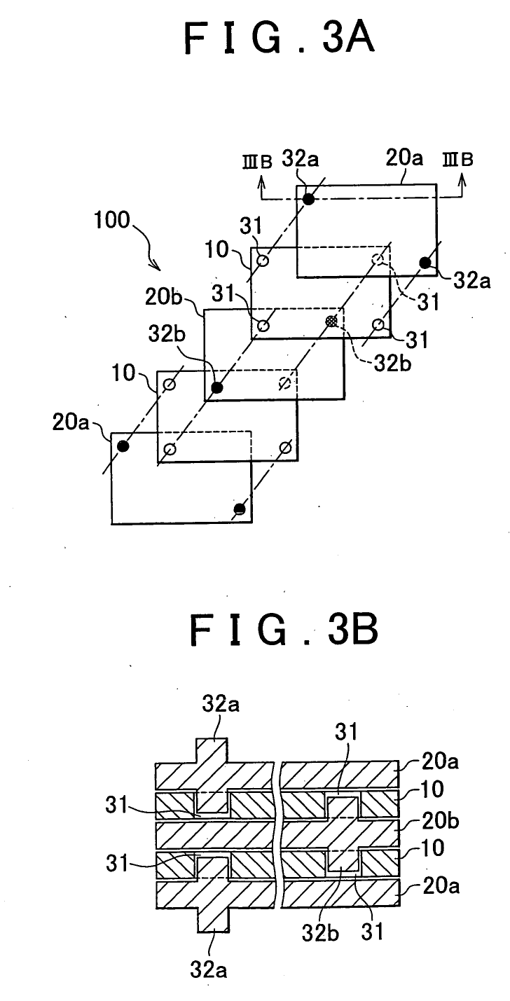

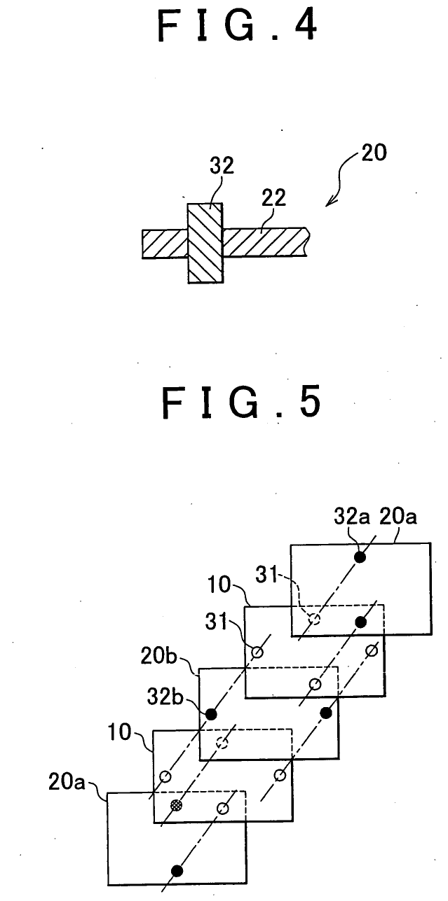

Next, the relationship between the protrusions 32 and the through-holes 31 will be described in detail. FIGS. 3A and 3B will be used to describe the positional relationship between the protrusions 32 and the through-holes 31. FIG. 3A is the exploded perspective view schematically showing the fuel cell 100. FIG. 3B is the cross-sectional view taken along the line IIIB-IIIB in FIG. 3A. To facilitate the description of the fuel cell 100 according to the first embodiment of the invention, the sealing gasket-combined MEAs 20, which are stacked alternately with the separators 10, will be alternately denoted by the reference numerals 20a and 20b. The protrusions 32 formed on each sealing gasket-combined MEA 20a will be referred to as protrusions 32a, and the protrusions 32 formed on each sealing gasket combined MEA 20b will be referred to as protrusions 32b. The manifolds, etc. described above with reference to FIGS. 2A to 2D are not shown in FIG. 3A.

As shown in FIG. 3A, the through-holes 31 are formed in the respective corner portions of each separator 10. The protrusions 32a are formed on both faces of the two diagonally opposite corner portions among the four corner portions of each scaling gasket-combined MEA 20a. Also, the protrusions 32b are formed on both faces of the two diagonally opposite corner portions among the four corner portions of each sealing gasket-combined MEA 20b. The two corner portions of the sealing gasket-combined MEA 20b, at which the protrusions 32b are formed, correspond to the two corner portions of the sealing gasket-combined MEA 20a, at which the protrusions 32a are not formed. The protrusions 32a and 32b are fitted in the respective through-holes 31.

With the structure described above, the separator 10 and the sealing gasket-combined MEA 20a are appropriately aligned with each other using the protrusions 32a and the through-holes 31. Similarly, the separator 10 and the sealing gasket-combined MEA 20b are appropriately aligned with each other using the protrusions 32b and the through-holes 31. Accordingly, an adhesive agent, etc. are no longer required to appropriately align the separators 10 and the sealing gasket-combined MEAs 20 with each other. As a result, the fuel cell 100 is produced at lower cost. In addition, because the protrusions 32 are formed at the diagonally opposite corner portions of each sealing gasket-combined MEA 20, the distance between the protrusions 32 used for alignment is relatively long. This suppresses curvature of the separator 10. As a result, high flatness of the separator 10 is achieved. In addition, the accuracy in aligning the separators 10 and the sealing gasket-combined MEAs 20a and 20b with each other increases.

Also, as shown in FIG. 3B, the positions of the protrusions 32a formed on the sealing gasket-combined MEA 20a differ from the positions of the protrusions 32b formed on the sealing gasket-combined MEA 20b. Namely, when viewed in the direction in which the sealing gasket-combined MEAs 20 and the separators 10 are alternately stacked (hereinafter, referred to as the “stacked direction”), the protrusions 32a and the protrusions 32b do not overlap with each other. In this case, it is possible to prevent the protrusions 32a and the protrusions 32b from interfering with each other. The invention produces effects on fuel cells where thick separators are used. However, the invention produces particularly intense effects on fuel cells where thin separators are used, such as the fuel cell 100 according to the first embodiment of the invention. Accordingly, the invention produces particularly intense effects on compact fuel cells.

In the first embodiment of the invention, the protrusions 32 are made of the same material as that of the sealing gasket portion 22. However, the protrusions 32 may be made of materials, such as hard rubber, that have elasticity lower than that of the sealing gasket portion 22. In this case, deformation of the protrusions 32 is suppressed. Thus, the accuracy in aligning the separators 10 and the sealing gasket-combined MEAs 20 with each other further increases. In this case, the protrusions 32 are formed by having, for example, hard rubber members pass through the sealing gasket portion 22 formed by injection-molding.

FIG. 5 shows another example of the positions at which the protrusions 32a and 32b are formed. As shown in FIG. 5, in each sealing gasket-combined MEA 20a, the protrusions 32a are formed on both faces of the center portion of each of the two opposite side portions. In each sealing gasket-combined MEA 20b, the protrusions 32b are formed on both faces of the center portion of each of the two opposite side portions. The two side portions of the sealing gasket-combined MEA 20b, on which the protrusions 32b are formed, correspond to the two side portions of the sealing gasket-combined MEA 20a, on which the protrusions 32a are not formed. In each separator 10, the through-holes 31 are formed in each side portion. The through-holes 31 are formed at the positions corresponding to the protrusions 32a and 32b. In this case, it is possible to appropriately align the separators 10 and the sealing gasket-combined MEAs 20a and 20b with each other without causing the protrusions 32a and the protrusions 32b to interfere with each other.

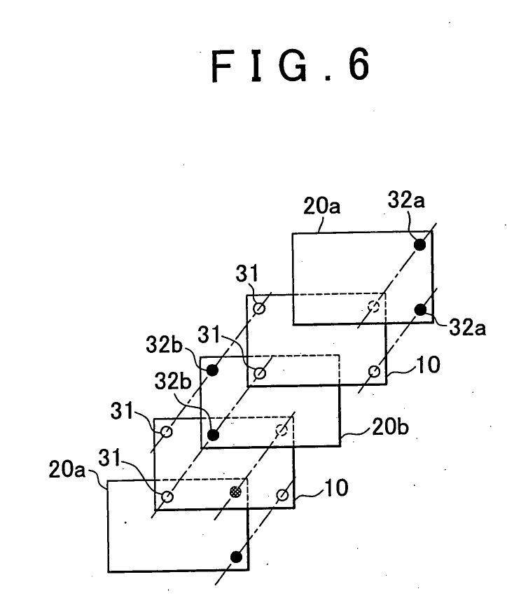

FIG. 6 is the view showing yet another example of the positions at which the protrusions 32a and 32b are formed. As shown in FIG. 6, in each sealing gasket-combined MEA 20a, the protrusions 32a are formed on both faces of the two corner portions at one end. In each sealing gasket-combined MEA 20b, the protrusions 32b are formed on both faces of the two corner portions at the other end. In each separator 10, the through-holes 31 are formed in the respective four corner portions. The through-holes 31 are formed at the positions corresponding to the protrusions 32a and 32b. In this case, it is possible to appropriately align the separators 10 and the sealing gasket-combined MEAs 20a and 20b with each other without causing the protrusions 32a and the protrusions 32b to interfere with each other.

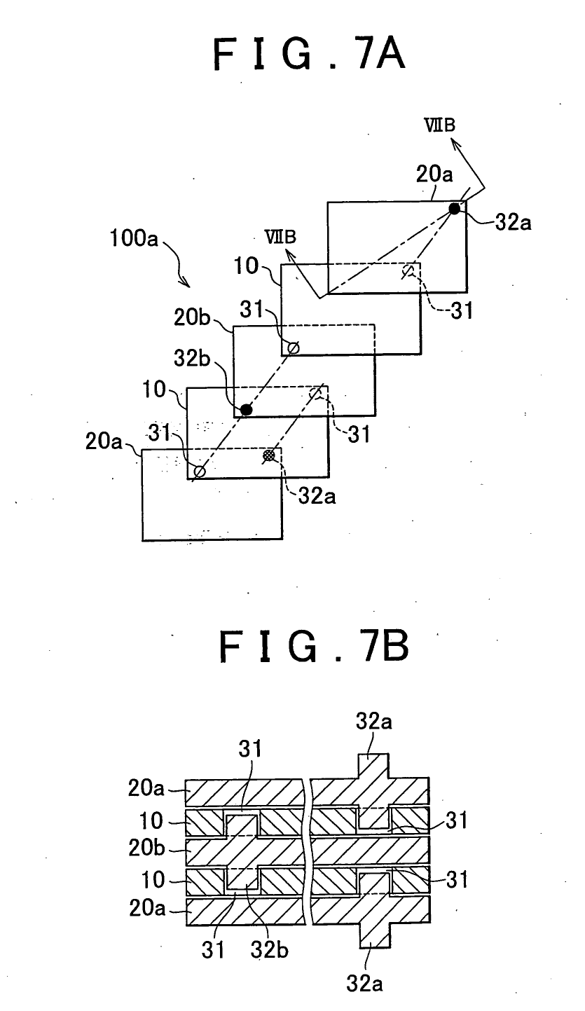

FIGS. 7A and 7B are the views used to describe a fuel cell 100a according to a second embodiment of the invention. The fuel cell 100a differs from the fuel cell 100 in FIG. 1 in that the protrusions 32 are formed on both faces of only one corner portion of each sealing gasket-combined MEA 20. The fuel cell 100a will be described below in detail. FIG. 7A is the exploded perspective view schematically showing the fuel cell 100a. FIG. 7B is the cross-sectional view taken along the line VIIB-VIIB in FIG. 7A.

As shown in FIG. 7A, in each sealing gasket-combined MEA 20a, the protrusions 32a are formed on both faces of one of the four corner portions. In each sealing gasket-combined MEA 20b, the protrusions 32b are formed on both faces of the corner portion diagonally opposed to the corner portion of the sealing gasket-combined MEA 20a, at which the protrusion 32a is formed. In each separator 10, the through-holes 31 are formed in the corner portions corresponding to the protrusions 32a and 32b. In this case, as shown in FIG. 7B, it is possible to appropriately align the separators 10 and the sealing gasket-combined MEAs 20a and 20b with each other without causing the protrusions 32a and the protrusions 32b to interfere with each other. In addition, because the number of the protrusions 32a and 32b is small, the fuel cell 100a is produced at lower cost.

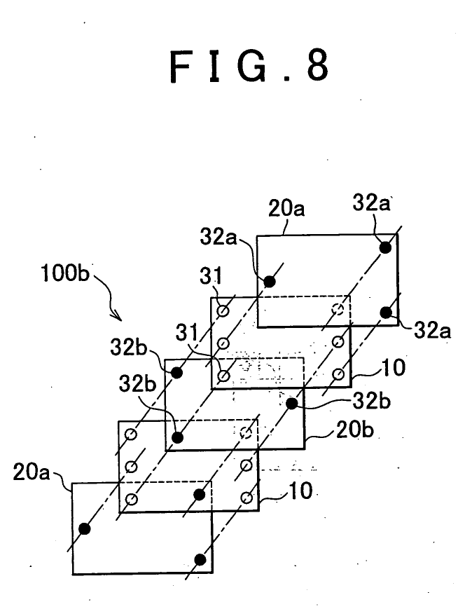

FIG. 8 is the exploded perspective view schematically showing a fuel cell 100b according to a third embodiment of the invention. The fuel cell 100b differs from the fuel cell 100 in FIG. 1 in that the protrusions 32 are formed on both faces of three portions of each sealing gasket-combined MEA 20. The fuel cell 100b will be described below in detail.

As shown in FIG. 8, in each sealing gasket-combined MEA 20a, the protrusions 32a are formed on both faces of each of the two corner portions at one end and both faces of the center portion of the side portion at the other end. In each sealing gasket-combined MEA 20b, the protrusions 32b are formed on both faces of the two corner portions at the other end and both faces of the center portion of the side portion at the one end. In each separator 10, the through-holes 31 are formed at the respective corner portions and the center portions of the side portions corresponding to the protrusions 32a and 32b. In this case, it is possible to appropriately align the separators 10 and the sealing gasket-combined MEAs 20a and 20b with each other without causing the protrusions 32a and the protrusions 32b to interfere with each other. Also, because six through-holes are formed in each separator 10, the accuracy in aligning the separators 10 and the sealing gasket-combined MEAs 20a and 20b with each other increases.

As described in the above embodiments of the invention, the effects of the invention are obtained as long as protrusions are formed on both faces of at least one portion of each sealing gasket-combined MEA 20, the through-holes 31, in which the protrusions 32 are fitted, are formed in each separator 10, and the positions of the protrusions 32 are different between the successive sealing gasket-combined MEAs 20. In the embodiments described above, the protrusions 32 are fitted in the respective through-holes 31. Alternatively, the protrusions 32 may be fitted in respective recesses formed instead of the through-holes 31.

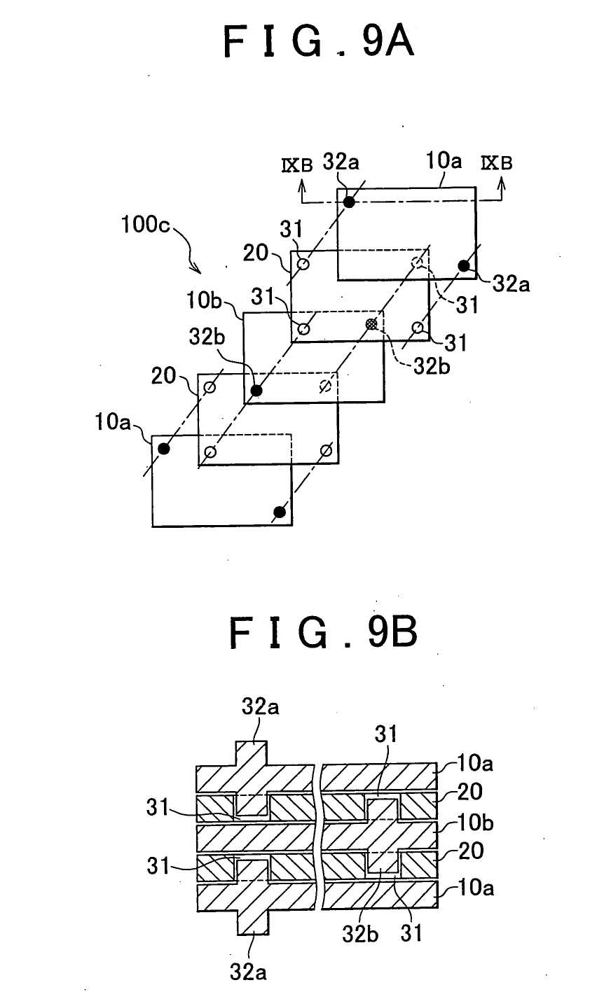

FIG. 9A is the exploded perspective view showing a fuel cell 100c according to a fourth embodiment of the invention. FIG. 9B is the cross-sectional view taken along the line IXB-IXB in FIG. 9B. The fuel cell 100c differs from the fuel cell 100 in FIG. 1 in that the through-holes 31 are formed in each sealing gasket-combined MEA 20, and the protrusions 32 are formed on both faces of each separator 10. To facilitate the description of the fuel cell 100c, the separators 10, which are stacked alternately with the sealing gasket-combined MEAs 20, will be alternately denoted by the reference numerals 10a and 10b. The protrusions formed on the separator 10a will be referred to as the protrusions 32a, and the protrusions formed on the separator 10b will be referred to as the protrusions 32b. The fuel cell 100c will be described below in detail.

As shown in FIG. 9A, the through-holes 31 are formed in the respective corner portions of each sealing gasket-combined MEA 20. The protrusions 32a are formed on both faces of the two diagonally opposite corner portions among the four corner portions of each separator 10a. Also, the protrusions 32b are formed on both faces of the two diagonally opposite corner portions among the four corner portions of each separator 10b. The corner portions, at which the protrusions 32b are formed, correspond to the corner portions of the separator 10a, at which the protrusions 32a are not formed. The protrusions 32a and 32b are fitted in the respective through-holes 31. In this case, as shown in FIG. 9B, it is possible to appropriately align the separators 10a, 10b and the sealing gasket-combined MEAs 20 with each other without causing the protrusions 32a and the protrusions 32b to interfere with each other.

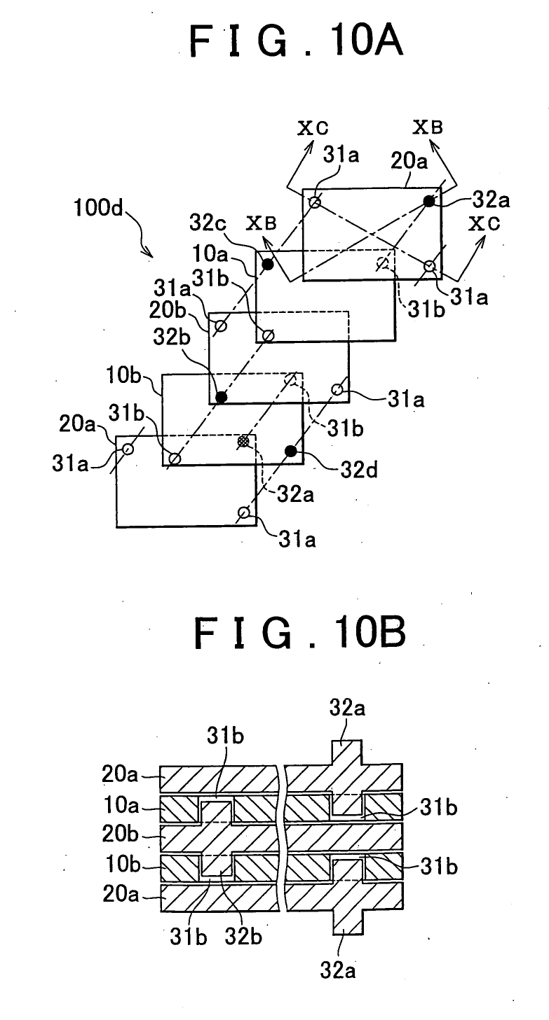

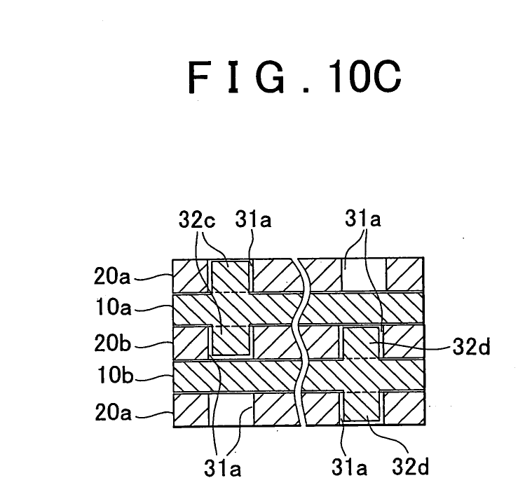

FIG. 10A is the exploded perspective view schematically showing a fuel cell 100d according to a fifth embodiment of the invention. FIG. 10B is the cross-sectional view taken along the line XB-XB in FIG. 10A. FIG. 10C is the cross-sectional view taken along the line XC-XC in FIG. 10A. The fuel cell 100d differs from the fuel cell 100 in FIG. 1 in that the through-holes 31a are formed in each sealing gasket-combined MEA 20, the protrusions 32 are formed on both faces of each sealing gasket-combined MEA 20, the through-holes 31b are formed in each separator 10, and the protrusions 32 are formed on both faces of each separator 10. To facilitate the description of the fuel cell 100d according to the fifth embodiment of the invention, the separators 10, which are stacked alternately with the sealing gasket-combined MEAs 20, will be alternately denoted by the reference numerals 10a and 10b. Also, the sealing gasket-combined MEAs 20, which are stacked alternately with the separators 10, will be alternately denoted by the reference numerals 20a and 20b. The protrusions formed on the sealing gasket-combined MEA 20a will be referred to as the protrusions 32a, and the protrusions formed on the sealing gasket-combined MEA 20b will be referred to as the protrusions 32b. The protrusions formed on the separator 10a will be referred to as the protrusions 32c, and the protrusions formed on the separator 10b will be referred to as the protrusions 32d. The fuel cell 100d will be described below in detail.

As shown in FIG. 10A, in each sealing gasket-combined MEA 20a, the protrusions 32a are formed on both faces of one of the four corner portions. In each sealing gasket-combined MEA 20b, the protrusions 32b are formed on both faces of the corner portion diagonally opposed to the corner portion of the sealing gasket-combined MEA 20a, at which the protrusions 32a are formed. In each separator 10a, the protrusions 32c are formed on both faces of one of the four corner portions. In each separator 10b, the protrusions 32d are formed on both faces of the corner portion diagonally opposed to the corner portion of the separator 10a, at which the protrusions 32c are formed. In each of the separators 10a and 10b, the through-holes 31b are formed in the corner portions corresponding to the protrusions 32a and 32b. In each of the sealing gasket-combined MEAs 20a and 20b, the through-holes 31a are formed in the corner portions corresponding to the protrusions 32c and 32d. In this case, as shown in FIGS. 10B and 10C, it is possible to appropriately align the separators 10a, 10b and the sealing gasket-combined MEAs 20a and 20b with each other without causing the protrusions 32a and 32b to interfere with each other or without causing the protrusions 32c and the protrusions 32d to interfere with each other.

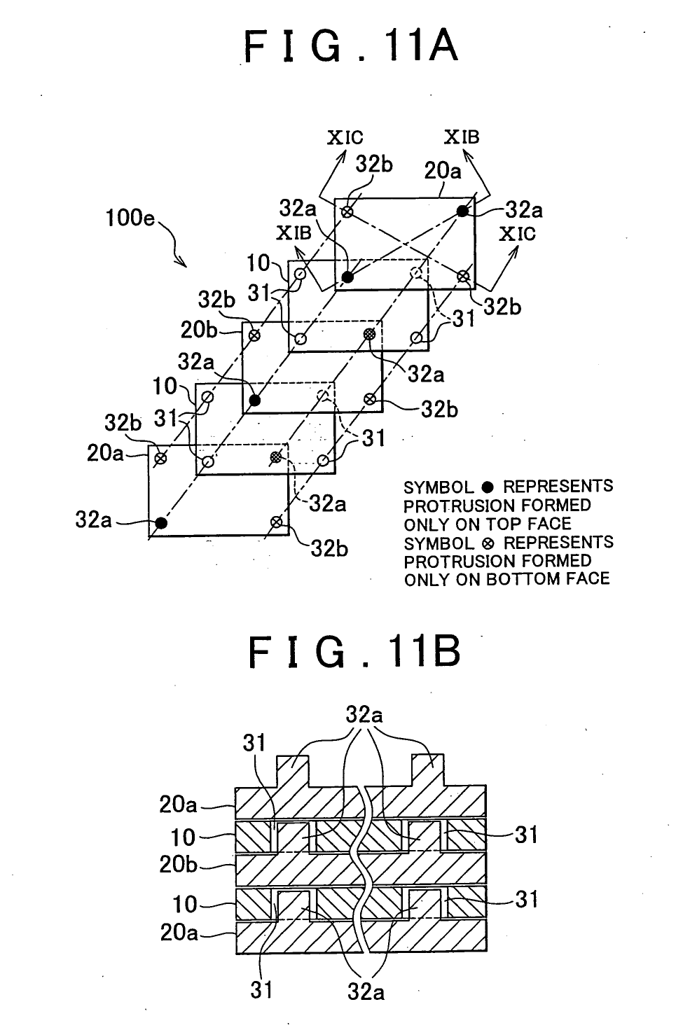

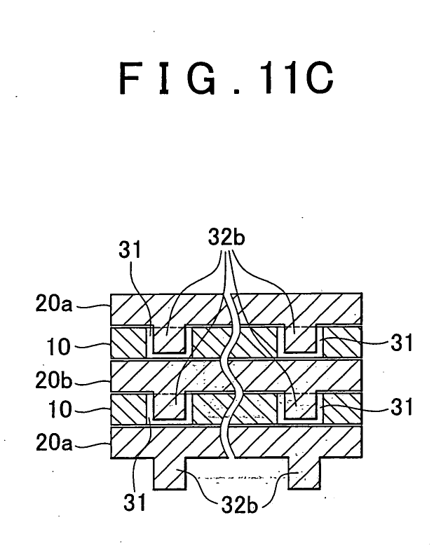

FIG. 11A is the exploded perspective view schematically showing a fuel cell 100e according to a sixth embodiment of the invention. FIG. 11B is the cross-sectional view taken along the line XIB-XIB in FIG. 11B. FIG. 11C is the cross-sectional view taken along the line XIC-XIC in FIG. 11A. The fuel cell 100e differs from the fuel cell 100 in FIG. 1 in that the through-holes 31 are formed in each separator 10, and the protrusions 32a are formed on one face of each sealing gasket-combined MEA 20, the protrusions 32b are formed on the other face of each sealing gasket-combined MEA 20, and the positions of the protrusions 32a differs from the positions of the protrusions 32b. To facilitate the description of the fuel cell 100e, the sealing gasket-combined MEAs 20, which are stacked alternately with the separators 10, will be alternately denoted by the reference numerals 20a and 20b. The protrusions 32, which are formed on the top face of each sealing gasket-combined MEA 20 and which extend upward in the stacked direction, will be referred to as the protrusions 32a. Also, the protrusions 32, which are formed on the bottom face of each sealing gasket-combined MEA 20 and which extend downward in the stacked direction, will be referred to as the protrusions 32b. The fuel cell 100e will be described below in detail.

As shown in FIG. 11A, in each of the sealing gasket-combined MEA 20a and 20b, the protrusions 32a are formed on the top face. The protrusions 32a are formed on the two diagonally opposite corner portions among the four corner portions. The protrusions 32b are formed on the bottom face of each of the sealing gasket-combined MEA 20a and 20b. The protrusions 32b are formed at the two diagonally opposite corner portions that correspond to the corner portions at which the protrusions 32a are not formed. In each separator 10, the through-holes 31 corresponding to the protrusions 32a and 32b are formed in the respective four corner portions. In this case, as shown in FIGS. 11B and 11C, it is possible to appropriately align the separators 10 and the sealing gasket-combined MEAs 20a and 20b with each other without causing the protrusions 32a and the protrusions 32b to interfere with each other.

1-22. (canceled)

23. A fuel cell, comprising:
separators; and
sealing gasket-combined membrane electrode assemblies stacked alternately with the separators, wherein
each sealing gasket-combined membrane electrode assembly includes a membrane electrode assembly and a sealing gasket portion, wherein
each sealing gasket portion or each separator has a protrusion formed on each face at the same or different positions with respect to both faces and extending in a stacked direction in which the separators and the sealing gasket-combined membrane electrode assemblies are stacked, wherein
each separator adjacent to the sealing gasket portion having the protrusion or each sealing gasket portion adjacent to the separator having the protrusion has a recess in which the protrusion is fitted, and wherein
each protrusion formed respectively on the opposed faces of the successive sealing gasket-combined membrane electrode assembly or the successive separator is located at a different position with respect to the protrusion in the preceding sealing gasket-combined membrane electrode assembly or the preceding separator along the stacking direction.

24. The fuel cell according to claim 23, wherein
each sealing gasket portion or each separator has the same number of protrusions on each face, and a pair of the protrusions formed respectively on one face and on the other face are located at the same position, and wherein
the paired protrusions formed on the successive sealing gasket-combined membrane electrode assembly or the successive separator are located at a different position with respect to the paired protrusions in the preceding sealing gasket-combined membrane electrode assembly or the preceding separator along the stacking direction.

25. The fuel cell according to claim 24, wherein
each sealing gasket portion has the paired protrusions, and each separator has the recess in which the protrusion is fitted.

26. The fuel cell according to claim 25, wherein
the paired protrusions are formed at two positions on each sealing gasket-combined electrode assembly.

27. The fuel cell according to claim 26, wherein
the paired protrusions are respectively formed at two diagonally opposite corner portions of each sealing gasket-combined membrane electrode assembly.

28. The fuel cell according to claim 27, wherein
the positions of the two diagonally opposite corner portions at which the paired protrusions are formed are different between the successive sealing gasket-combined membrane electrode assemblies.

29. The fuel cell according to claim 26, wherein
the paired protrusions are respectively formed at center portions of two opposite side portions of each sealing gasket-combined membrane electrode assembly.

30. The fuel cell according to claim 26, wherein
the paired protrusions are respectively formed at two corner portions at one end of each sealing gasket-combined membrane electrode assembly.

31. The fuel cell according to claim 25, wherein
the paired protrusions are formed at one position on each sealing gasket-combined electrode assembly.

32. The fuel cell according to claim 31, wherein
the paired protrusions are formed at one corner portion of each sealing gasket-combined membrane electrode assembly.

33. The fuel cell according to claim 25, wherein
the paired protrusions are formed at three positions on each sealing gasket-combined electrode assembly.

34. The fuel cell according to claim 33, wherein
the paired protrusions are respectively formed at two corner portions at one end of each sealing gasket-combined membrane electrode assembly, and at a center portion of a side portion on the other end of each sealing gasket-combined membrane electrode assembly.

35. The fuel cell according to claim 25, wherein
the protrusion is made of the same material as that of the sealing gasket portion.

36. The fuel cell according to claim 25, wherein
the protrusion is made of a material that has elasticity lower than that of the sealing gasket portion.

37. The fuel cell according to claim 24, wherein
each separator has the paired protrusions, and each sealing gasket portion has the recess in which the protrusion is fitted.

38. The fuel cell according to claim 37, wherein
the paired protrusions are formed at two positions on each separator.

39. The fuel cell according to claim 38, wherein
the paired protrusions are respectively formed at two diagonally opposite corner portions of each separator.

40. The fuel cell according to claim 39, wherein
the positions of the two diagonally opposite corner portions at which the paired protrusions are formed are different between the successive separators.

41. The fuel cell according to claim 23, wherein
a cooling medium passage is formed in the separator.

42. The fuel cell according to claim 23, wherein
the recess is a through-hole.

43. The fuel cell according to claim 23, wherein
the recess is not a through-hole.

44. The fuel cell according to claim 23, wherein
each sealing gasket portion and each separator have the same number of protrusions on each face, a pair of the protrusions formed respectively on one face and on the other face are located at the same position, the paired protrusions formed on the sealing gasket portion are located at a position different from the separator adjacent to the sealing gasket portion, and wherein
the sealing gasket portion and the separator have the recess in which the protrusions respectively formed on the adjacent separator and on the adjacent sealing gasket portion are fitted.

45. The fuel cell according to claim 23, wherein
each sealing gasket portion or each the separator has a protrusion on each face, and the protrusions respectively formed on opposite faces are located at different positions, and wherein
each separator adjacent to the sealing gasket portion having the protrusion or each sealing gasket portion adjacent to the separator having the protrusion has a recess in which the protrusion is fitted.
